(19) United States
(12) Patent Application Publication
(10) Pub. No.: US 2019/0254298 A1
(43) Pub. Date: Aug. 22, 2019

(54) COUNTERTOP PRODUCE-PRESERVATION DEVICE

(71) Applicant: Haier US Appliance Solutions, Inc., Wilmington, DE (US)

(72) Inventor: Daniel Carballo, Louisville, KY (US)

(21) Appl. No.: 15/900,895

(22) Filed: Feb. 21, 2018

(51) Int. Cl. A23B 7/04; F24F 6/04

(52) U.S. Cl. CPC A23B 7/0425; F24F 6/043

(57) ABSTRACT

A countertop produce-preservation device is provided herein. The countertop produce-preservation device may include a housing, a fan, and a porous evaporative medium. The housing may include an outer shell and an inner shell partially enclosed within the outer shell to define an air passage therebetween. The inner shell may define a produce opening and a preservation chamber to receive produce therein. The outer shell may define an air inlet and an air outlet in fluid communication with the air passage. The fan may be in fluid communication with the air passage to motivate an airflow from the air inlet to the air outlet. The porous evaporative medium may be positioned within the outer shell along the air passage.

### FIELD OF THE INVENTION

The present subject matter relates generally to systems for preserving produce, such as fruit or vegetables, and more particularly to stand-alone produce-preservation devices that can be mounted or positioned on a consumer countertop.

### BACKGROUND OF THE INVENTION

Keeping perishable produce items, such as fruits, fresh has been a long-standing problem for consumers. Trying to ripen certain fruits, for instance, without allowing them to quickly spoil can be a challenge for many consumers. As an example, when exposed to the ambient temperatures of a typical home environment (e.g., between 69° Fahrenheit and 75° Fahrenheit), some fruits may quickly ripen, but bacteria or mold growth may be promoted, causing the fruit to quickly spoil. In an effort to maintain freshness, many consumers store perishable produce items in a refrigerator appliance. Typical refrigerator appliances have a cabinet that defines a chilled fresh food chamber maintained at a temperature between 32° Fahrenheit and 45° Fahrenheit. In particular, one or more drawers are often provided within the fresh food chamber to hold produce at the same temperature as the rest of the chilled refrigeration chamber.

Although a typical refrigerator appliance may preserve produce longer than if it were exposed to ambient home conditions, many additional problems may be created. For example, some produce may be prevented from quickly ripening within the relatively cold conditions of a chilled fresh food chamber. Moreover, many fruits and vegetables deteriorate at such conditions (e.g., temperatures around 40° Fahrenheit). However, meats and dairy products within the fresh food chamber may deteriorate at higher temperatures above 40° Fahrenheit. Humidity levels within the chilled fresh food chamber may accelerate deterioration of produce. Furthermore, although different fruits or vegetables may preserve better at different conditions, the chilled fresh food chamber cannot be easily or specifically adjusted to accommodate such different conditions.

For many consumers, it would be difficult, if not impossible, to have multiple different refrigerator appliances that could be set at the ideal conditions for one or more types of produce. What's more, placing produce within a large, often opaque, appliance like a refrigerator appliance may increase the likelihood that an item of produce is forgotten and allowed to spoil.

Therefore, there is a need for a food preservation system that addresses one or more of the above-identified issues.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a countertop produce-preservation device is provided. The countertop produce-preservation device may include a housing, a fan, and a porous evaporative medium. The housing may include an outer shell and an inner shell partially enclosed within the outer shell to define an air passage therebetween. The inner shell may define a produce opening and a preservation chamber to receive produce therein. The outer shell may define an air inlet and an air outlet in fluid communication with the air passage. The fan may be in fluid communication with the air passage to motivate an airflow from the air inlet to the air outlet. The porous evaporative medium may be positioned within the outer shell along the air passage to direct a vaporized cooling liquid thereto upstream from the air outlet.

In another exemplary aspect of the present disclosure, a countertop produce-preservation device is provided. The countertop produce-preservation device may include a housing, a fan, a porous evaporative medium, and a liquid reservoir. The housing may include an outer shell and an inner shell partially enclosed within the outer shell to define an air passage therebetween. The inner shell may define a produce opening and a preservation chamber to receive produce therein. The outer shell may define an air inlet and an air outlet in fluid communication with the air passage. The fan may be in fluid communication with the air passage to motivate an airflow from the air inlet to the air outlet. The porous evaporative medium may be positioned within the outer shell along the air passage in fluid communication between the air inlet and the air outlet. The liquid reservoir may be in fluid communication with the porous evaporative medium to supply a liquid coolant thereto.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a preservation device according to exemplary embodiments of the present disclosure.

FIG. 2 provides a perspective view of the exemplary embodiment of FIG. 1, with the door removed for clarity.

FIG. 3 provides a cross-sectional schematic view of a preservation device according to exemplary embodiments of the present disclosure.

FIG. 4 provides a schematic view of a preservation device according to exemplary embodiments of the present disclosure.

FIG. 5 provides a perspective view of a preservation device according to alternative exemplary embodiments of the present disclosure.

FIG. 6 provides a flow chart illustrating a method of operating a preservation device in accordance with example embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In order to aid understanding of this disclosure, several terms are defined below. The defined terms are understood to have meanings commonly recognized by persons of ordinary skill in the arts relevant to the present invention. The terms “includes” and “including” are intended to be inclusive in a manner similar to the term “comprising.” Similarly, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows.

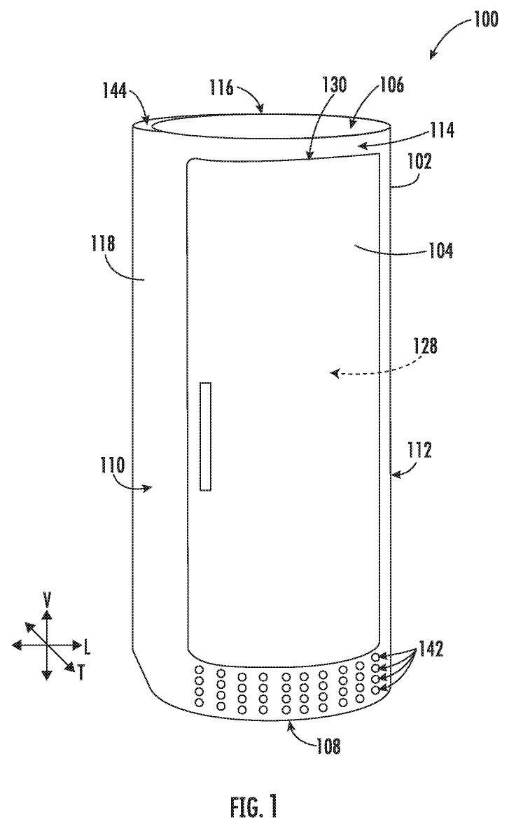

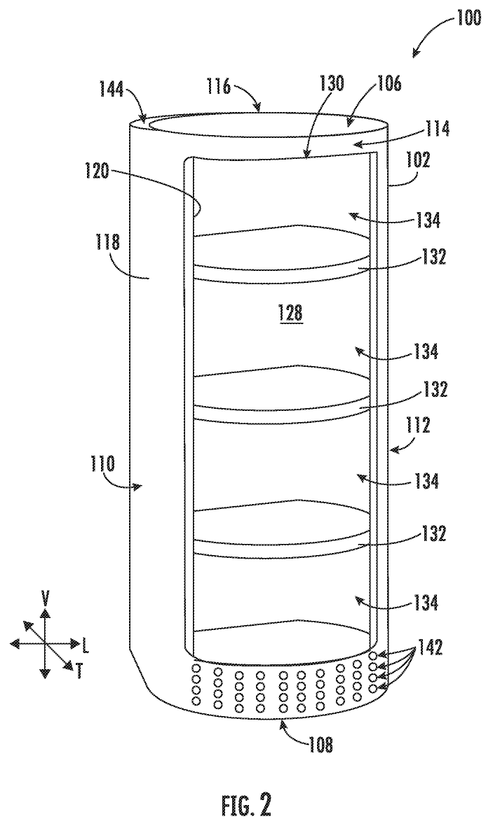

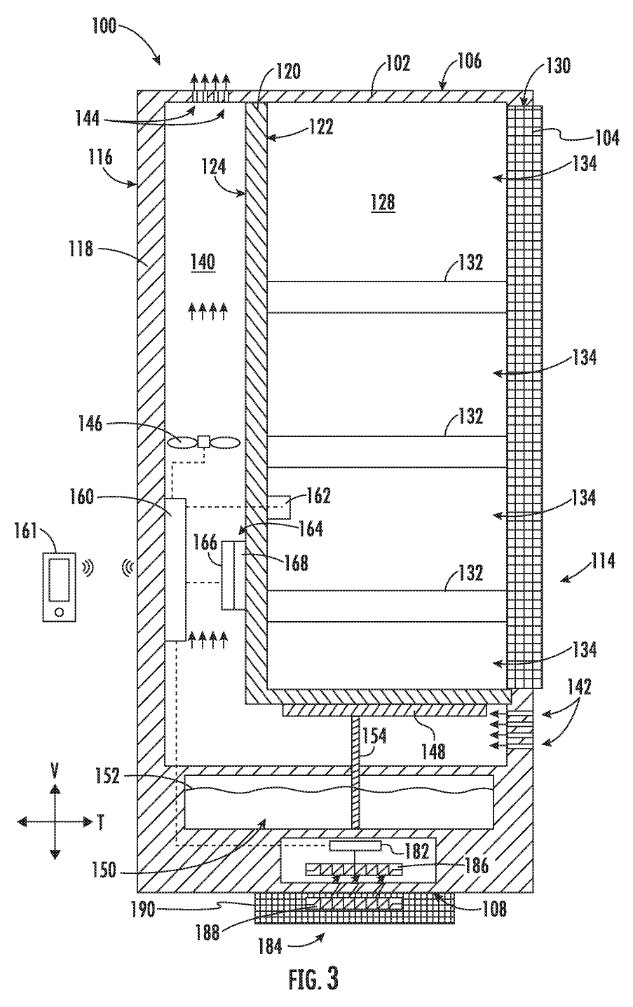

Turning now to the figures, FIGS. 1 through 3 illustrate a preservation device 100 according to exemplary embodiments of the present disclosure. In particular, FIG. 1 provides a perspective view of preservation device 100 having a housing 102 to which a door 104 is movably attached. FIG. 2 provides another perspective view of preservation device 100, wherein door 104 has been removed for the purposes of clarity. FIG. 3 provides a cross-sectional schematic view of preservation device 100.

As shown, housing 102 extends along a defined vertical direction V between a top end 106 and a bottom end 108; along a defined lateral direction L between a first side 110 and a second side 112; and between a defined transverse direction T between a front end 114 and a rear end 116. The vertical direction V, the lateral direction L, and transverse direction T are each mutually-perpendicular and form an orthogonal direction system.

Generally, housing 102 includes an outer shell 118 and an inner shell 120 formed according to a suitable size and shape, for instance, to sit on a typical consumer countertop. When assembled, inner shell 120 is at least partially enclosed within outer shell 118 and defines a preservation chamber 128 to receive and store produce items therein. A produce opening 130 defined by inner shell 120 (e.g., through outer shell 118) generally permits access to preservation chamber 128. Thus, produce may be placed into (or alternately removed from) preservation chamber 128 through produce opening 130.

In some embodiments, inner shell 120 is formed, at least in part, from a conductive material (e.g., conductive metal), such as aluminum, copper, steel, etc. (including alloys thereof). In additional or alternative embodiments, outer shell 118 is formed from an insulating material (e.g., a rigid insulating polymer or plastic), such as acrylic, polyethylene, polypropylene, etc.

Generally, door 104 may be movably attached to housing 102 to move between a closed position (FIGS. 1 and 3) and an open position (not pictured). In the closed position, door 104 covers or spans produce opening 130 to restrict access to preservation chamber 128. By contrast, in the open position, door 104 is positioned away from produce opening 130 to permit access to preservation chamber 128 through produce opening 130 (e.g., similar to FIG. 2). In exemplary embodiments, door 104 is rotatably connected to outer shell 118 at one end or side (e.g., second side 112), as shown in FIG. 1. However, it should be understood that any other suitable position may be provided to permit selective opening and closing of preservation chamber 128.

In optional embodiments, one or more shelves 132 are positioned within housing 102. For instance, shelves 132 may be mounted to inner shell 120 within preservation chamber 128 to hold produce stored inside preservation device 100. Optionally, multiple shelves 132 may be spaced apart from each other (e.g., along the vertical direction V). Sub-chambers 134 may thus be defined (e.g., in the vertical direction V) between adjacent shelves 132. Certain shelves 132 may restrict the flow of air or gases along the vertical direction V (e.g., when door 104 is in the closed position). For example, such shelves 132 may be formed as solid non-permeable members to prevent gases from passing therethrough from one sub-chamber 134 to another sub-chamber 134. Produce stored in one sub-chamber 134 may thus be prevented from fluid communication with produce stored in another sub-chamber 134. Additional or alternative shelves 132 may permit the free flow of air or gases along the vertical direction V. For example, such shelves 132 may be formed as permeable (e.g., latticed or mesh) members to permit gas to pass therethrough from one sub-chamber 134 to another sub-chamber 134. Produce stored in one sub-chamber 134 may thus direct one or more gases (e.g., ethylene emitted by produce therein) to another sub-chamber 134.

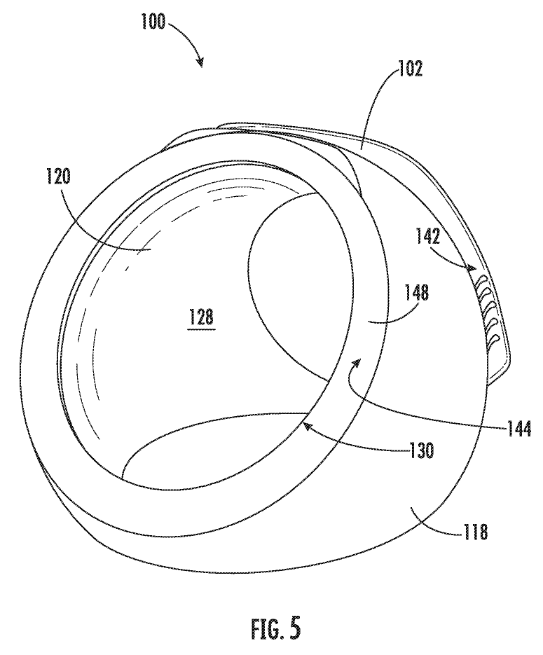

Although the exemplary embodiments of FIGS. 1 through 3 illustrate preservation device 100 as defining a cylindrical preservation chamber 128 having a plurality of shelves 132 positioned therein, it is understood that any suitable form or shape may be provided. For instance, turning briefly to FIG. 5, alternative embodiments of preservation device 100 define a curved (e.g., asymmetrically-curved) or bowl-shaped preservation chamber 128 that may be free of discrete sub-chambers.

Turning especially to FIG. 3, an air passage 140 is defined between inner shell 120 and outer shell 118. As shown, inner shell 120 defines an internal surface 122 and an opposite external surface 124. Internal surface 122 is directed toward the preservation chamber 128, and the external surface 124 is directed toward the air passage 140. Thus, air passage 140 may be defined between the external surface 124 of inner shell 120 and outer shell 118 (e.g., at an internal surface of outer shell 118).

In some embodiments, outer shell 118 defines a discrete air inlet 142 and air outlet 144 in fluid communication with air passage 140, thus permitting air to flow from the ambient environment and through the air passage 140 before being returned to the ambient environment (e.g., at an elevated temperature). During certain use conditions, such as when door 104 is in the closed position, preservation chamber 128 may be in fluid isolation from air passage 140. Thus, air within air passage 140 may be prevented from passing to preservation chamber 128, and vice versa.

In some embodiments, a blower or fan 146 is provided in fluid communication with air passage 140. For instance, fan 146 may be mounted within outer shell 118 (e.g., along air passage 140). Fan 146 may be positioned downstream from air inlet 142 and upstream from air outlet 144. During use, fan 146 may thus rotate to motivate an airflow from air inlet 142 to air outlet 144 through air passage 140, as further described below. Optionally, fan 146 may be provided as a variable speed fan configured to selectively vary its rotation speed and thus vary the rate (e.g., volumetric flow rate) of the airflow through air passage 140.

Within air passage 140, preservation device 100 includes a porous evaporative medium 148. Specifically, porous evaporative medium 148 is positioned within outer shell 118 along air passage 140. Porous evaporative medium 148 may be upstream or downstream from fan 146 (i.e., in fluid communication therewith). Moreover, when assembled, porous evaporative medium 148 is in fluid communication with and between air inlet 142 and air outlet 144. At least a portion of the airflow through air passage 140 may thus pass over, across, or through porous evaporative medium 148.

Generally, porous evaporative medium 148 is formed from one or more porous media. Specifically, porous evaporative medium 148 includes a porous material within which a liquid coolant 152 (e.g., water) may be held and at least partially released to the airflow as the airflow passes over, across, or through porous evaporative medium 148. As an example, porous evaporative medium 148 may include one or more paper or cellulose filtration sheets. As an additional or alternative example, porous evaporative medium 148 may include a moisture-retaining fabric, such as cotton.

In certain embodiments, a liquid reservoir 150 is provided in fluid communication with porous evaporative medium 148 to supply the liquid coolant 152 thereto. Generally, a supplied volume of the liquid coolant 152 may be stored or held within reservoir 150. During use, at least a portion of liquid coolant 152 may be slowly supplied to porous evaporative medium 148. For instance, as illustrated in FIG. 3, a wicking segment 154 may extend from porous evaporative medium 148 to liquid reservoir 150 (e.g., along the vertical direction V or any other suitable direction). Liquid coolant 152 within liquid reservoir 150 may thus be supplied to porous evaporative medium 148 by a capillary action through wicking segment 154. Optionally, liquid reservoir 150 may be positioned below porous evaporative medium 148. Additionally or alternatively, at least a portion of porous evaporative medium 148 is positioned within liquid reservoir 150 to directly draw or wick liquid coolant 152 to another portion of porous evaporative medium 148 (e.g., above or otherwise spaced apart from liquid reservoir 150).

From porous evaporative medium 148, liquid coolant 152 may vaporize and mix or entrain with the airflow to the airflow within air passage 140 before flowing to the ambient environment. Moreover, liquid coolant 152 may absorb heat from airflow and (optionally) inner shell 120 as it undergoes the vapor phase change. Heat may be drawn from preservation chamber 128 (e.g., through inner shell 120) as the vaporized coolant is flowed through the air passage 140.

As shown in FIG. 3, exemplary embodiments provide porous evaporative medium 148 is on or against inner shell 120. In particular, at least a portion of porous evaporative medium 148 is positioned in conductive thermal communication (e.g., direct or indirect contact) with the external surface 124 of the inner shell 120. Heat may thus be conducted from inner shell 120 to porous evaporative medium 148 and the liquid coolant 152 therein.

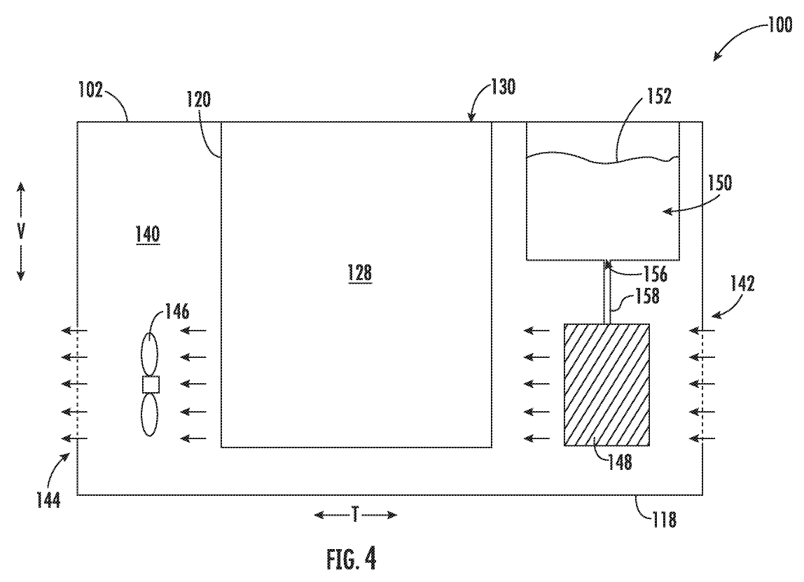

Turning briefly to FIG. 4, some embodiments of preservation device 100 maintain porous evaporative medium 148 at a spaced-apart location from inner shell 120. For example, porous evaporative medium 148 may be positioned along air passage 140 upstream or downstream from all or some of inner shell 120. During use, thermal communication between porous evaporative medium 148 and inner shell 120 may be substantially convective and free of significant conductive heat exchange.

Moreover, in additional or alternative embodiments, liquid reservoir 150 may be spaced apart from (e.g., positioned above) porous evaporative medium 148. A liquid outlet 156 defined through liquid reservoir 150 may slowly release or permit liquid from liquid reservoir 150 to porous evaporative medium 148 (e.g., directly or, alternatively, via one or more intermediate conduits 158). Optionally, liquid outlet 156 may be defined to have a predetermined diameter (e.g., between 0.01 inches and 0.02 inches) configured to control the slow release of liquid to porous evaporative medium 148.

As would be understood in light of the current disclosure, additional embodiments may be provided by combining one or more of the features of the exemplary embodiments of FIGS. 1 through 4. As an example, some embodiments may include multiple stages of porous evaporative media. One stage may provide porous evaporative media at a spaced-apart location from the inner shell, as shown in FIG. 4. A second discrete stage may be separated (e.g., not directly connected or downstream) from the first stage along the defined air passage between the inner shell and the outer shell. In some such embodiments, the second stage provides additional porous evaporative media. That additional porous evaporative media may be positioned in conductive thermal communication (e.g., direct or indirect contact) with the external surface of the inner shell, as shown in FIG. 3. As would be understood, further embodiments may include additional stages separated from or in contact with the inner shell.

During operation of the disclosed embodiments of device 100, heat exchanged through air passage 140 may notably lower the temperature within the preservation chamber 128 to suitable temperature for produce preservation (e.g., between 55° Fahrenheit and 65° Fahrenheit) that is below a typical ambient temperature and above the produce-degrading temperatures of a typical refrigeration appliance. Advantageously, the instantaneous power draw required for a heat exchange cycle may be relatively low (e.g., when compared to typical cooling cycles provided by a sealed refrigerant system). For instance, the power required to complete heat exchange may be between 1 Watts and 5 Watts instead of between 40 Watts and 60 Watts that may be required for a similar cooling performance from a sealed refrigerant system. Moreover, the space and mass required is relatively low and may permit device 100 to be positioned or mounted at a variety of locations that would otherwise be unsuitable for refrigerant systems (e.g., a consumer countertop).

Returning to FIGS. 1 through 3, operation of the preservation device 100 can be generally controlled or regulated by a controller 160. For example, controller 160 is in operative communication with (e.g., electrically or wirelessly coupled to) fan 146. Thus, controller 160 can selectively activate and operate fan 146 according to one or more desired operations.

In some embodiments, controller 160 is in operative communication to a user interface 161 (e.g., interface panel) or various other components, as will be described below. The user interface 161 may be provided directly on housing 102 or, alternatively, separate and independent from housing 102. For instance, the user interface 161 may be a computer (e.g., a desktop computer or a laptop), a tablet, a personal telephone (e.g., a suitable smartphone), a television (e.g., a smart television) or an independent device which functions solely to operate and communicate with the various other components of preservation device 100. For instance, the user interface 161 may communicate with the controller 160 over one or more wireless networks, such as a local area network (e.g., intranet), wide area network (e.g., internet), low power wireless networks [e.g., Bluetooth Low Energy (BLE)], or some combination thereof and can include any number of wired or wireless links. Generally, the user interface 161 may provide selections for user manipulation of the operation of preservation device 100. As an example, the user interface 161 may provide for selections between specific fruits, desired ripeness, or a desired temperature within preservation chamber 128. In response to one or more input signals (e.g., from user manipulation of the user interface 161 or one or more sensor signals), controller 160 may operate various components of preservation device 100 according to the current mode of operation.

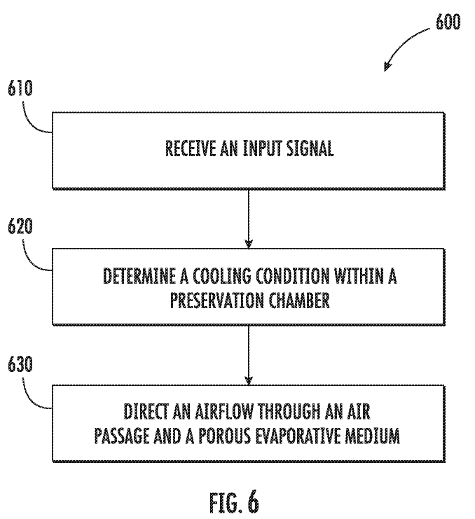

Controller 160 may include a memory (e.g., non-transitive memory) and one or more microprocessors, CPUs or the like, such as general or special purpose microprocessors operable to execute programming instructions or micro-control code associated with operation of preservation device 100. The memory may represent random access memory such as DRAM, or read only memory such as ROM or FLASH. In some embodiments, the processor executes programming instructions stored in memory. For certain embodiments, the instructions include a software package configured to operate preservation device 100 (e.g., execute an operation routine including the example method 600 described below with reference to FIG. 6). The memory may be a separate component from the processor or may be included onboard within the processor. Alternatively, controller 160 may be constructed without using a microprocessor (e.g., using a combination of discrete analog or digital logic circuitry, such as switches, amplifiers, integrators, comparators, flip-flops, AND gates, and the like) to perform control functionality instead of relying upon software.

Controller 160, or portions thereof, may be positioned in a variety of locations throughout preservation device 100. In example embodiments, controller 160 is located within air passage 140. In other embodiments, the controller 160 may be positioned at any suitable location within preservation device 100. Input/output (“I/O”) signals may be routed between controller 160 and various operational components of preservation device 100. For example, fan 146 and one or more sensors (e.g., temperature sensors 162) may be in communication with controller 160 via one or more signal lines or shared communication busses.

As illustrated, controller 160 may be in operative communication with to the various components of preservation device 100 and may control operation of the various components, such as fan 146. Optionally, various operations, such as rotation of fan 146 may occur based on user input or automatically through controller 160 instruction.

In some embodiments, controller 160 includes a predetermined range or threshold for temperature in preservation chamber 128. For example, the predetermined range or threshold may be an absolute value of a contemporary temperature. Alternatively, the predetermined range or threshold could be of a value of degrees or seconds at which a contemporary temperature is below a set point value (e.g., 60° Fahrenheit).

Generally, the rate of heat exchange between the preservation chamber 128 and air passage 140 is correlated to the flow rate (e.g., volumetric flow rate) of the airflow through air passage 140. Activation or speed of fan 146 may be at least partially based on the temperature within preservation chamber 128. Controller 160 is configured to receive a temperature signal from temperature sensor 162. In some such embodiments, temperature sensor 162 is a suitable electrical thermistor or thermocouple disposed within preservation chamber 128. According to the received temperature signal, controller 160 is configured to determine a contemporary temperature. A contemporary temperature within preservation chamber 128 that is above the predetermined range or threshold may be indicative of an excessive temperature for fruit storage. A contemporary temperature that is below the predetermined range or threshold may be indicative of excessively-cooled preservation chamber 128. Based upon the determined contemporary temperature, rotation of fan 146 may be increased, decreased, or maintained. Optionally, a new target speed for fan 146 may be selected by controller 160 before being transmitted to fan 146. The target speed may be determined according to a selected type of vegetable or fruit (e.g., via a predetermined look-up table, formula, or model).

In optional embodiments, one or more secondary cooling devices 164 are provided in thermal communication with preservation chamber 128. For instance, at least a portion of secondary cooling device 164 may be positioned within housing 102 (e.g., within air passage 140). In some such embodiments, secondary cooling device 164 may be in operative communication with controller 160. Activation of secondary cooling device 164 may thus be contingent on, for instance, a measured temperature within preservation chamber 128.

Secondary cooling device 164 may be provided as any suitable selectively-activated cooling system. For instance, in certain embodiments, secondary cooling device 164 is a thermo-electric heat exchanger (TEHE 164) in thermal communication with preservation chamber 128. Generally, TEHE 164 may be any suitable solid state, electrically-driven heat pump, such as a Peltier device. TEHE 164 may include a distinct hot side 166 and cold side 168. A heat flux created between the junction of hot side 166 and cold side 168 may draw heat from the cold side 168 to the hot side 166 (e.g., as driven by an electrical current). Thus, when active, the cold side 168 of TEHE 164 may be maintained at a lower temperature than the hot side 166 of TEHE 164. In some embodiments, TEHE 164 is in operative communication with (e.g., electrically coupled to) controller 160, which may thus control the flow of current to TEHE 164.

Although TEHE 164 is illustrated as a generally solid member in FIG. 3, alternative embodiments may include one or more fin members (e.g., attached to or formed on hot side 166 or cold side 168) extending within air passage 140 or preservation chamber 128, thereby increasing the surface area of TEHE 164. For instance, one or more fins may extend from the hot side 166 within air passage 140 while one or more other fins extend from the cold side 168 within preservation chamber 128.

As shown, TEHE 164 may be attached (e.g., mechanically connected directly or indirectly) to inner shell 120. For instance, TEHE 164 may be mounted in thermal and fluid communication with air passage 140. In some such embodiments, at least a portion of TEHE 164 is positioned within air passage 140. For instance, the hot side 166 may be disposed within air passage 140. Additionally or alternatively, the cold side 168 may be in contact with the external surface 124 of inner shell 120. In the exemplary embodiments of FIG. 3, TEHE 164 is disposed within air passage 140 in fluid communication with fan 146. During operations, heat may thus be drawn from preservation chamber 128 and to air passage 140 through TEHE 164. Such heat energy may be further absorbed by air flowing through air passage 140 before being motivated to air outlet 144. Advantageously, TEHE 164 may accelerate the heat exchange between preservation chamber 128 and air passage 140 without permitting air from air passage 140 to preservation chamber 128.

In additional or alternative embodiments, a direct-current power source 182 (e.g., battery) may be provided within preservation device 100 (e.g., to power operations thereof). For instance, direct-current power source 182 may be positioned within the housing 102 in electrical communication with controller 160. Optionally, direct-current power source 182 may be in electrical communication with fan 146 or TEHE 160 (e.g., directly or indirectly through controller 160).

In exemplary embodiments, direct-current power source 182 is a rechargeable battery formed of, for instance, lithium-ion, nickel-cadmium (NiCd), nickel-metal hydride (NiMH), etc. In some such embodiments, a battery charger 184 is provided to selectively recharge direct-current power source 182 when operably coupled therewith. For instance, battery charger 184 may be provided as a pair of matched induction coils 186, 188. A first induction coil 186 may be mounted or fixed to device 100 (e.g., outer shell 118) and, thereby, moves with housing 102. A second induction coil 188 may be mounted or fixed to a discrete charging mat 190 separate from housing 102. As illustrated, second induction coil 188 may initiate an electromagnetic field to be transmitted therefrom. The transmitted electromagnetic field may then be received by the first induction coil 186 (i.e., when inductively coupled thereto). In the charging position of FIG. 3, the matched induction coils 186, 188 may be aligned (e.g., vertically aligned), such that the second induction coil 188 is inductively coupled to first induction coil 186.

Turning now to FIG. 6, a flow chart is provided of method 600 according to exemplary embodiments of the present disclosure. Generally, the method 600 provides for methods of operating a preservation device 100 (e.g., FIG. 3) that includes a housing 102 defining an air passage 140 in fluid communication with a fan 146 and porous evaporative medium 140, as described above. The method 600 can be performed, for instance, by the controller 160. For example, controller 160 may, as discussed, be in operative communication with one or more sensor(s) 162, fan 146, secondary cooling device 164, direct-current power source 182, or user interface 161. During operations, controller 160 may send signals to and receive signals from sensor 162, fan 146, secondary cooling device 164, or user interface 161. Controller 160 may further be in operative communication with other suitable components of the device 100 to facilitate operation of the device 100 generally. FIG. 6 depicts steps performed in a particular order for purpose of illustration and discussion. Except as otherwise omitted or necessarily constrained, those of ordinary skill in the art, using the disclosures provided herein, will understand that the steps of any of the methods disclosed herein can be modified, adapted, rearranged, omitted, or expanded in various ways without deviating from the scope of the present disclosure.

At 610, the method 600 includes receiving one or more input signals. For instance, an input signal may be received from the user interface in response to an input provided by the user. The input signal may include or be an embodied as an activation signal indicating desired cooling of the preservation chamber. Additionally or alternatively, the input signal may include one or more desired characteristics of the preservation chamber. As an example, the input signal may include a desired temperature within the preservation chamber. As another example, the input signal may include a produce input signal. The produce input signal generally includes information regarding the type of produce being placed within the preservation chamber. Thus, a user may specify one or more type of fruits or vegetables (e.g., banana, apple, strawberry, lettuce, etc.) that is stored with preservation chamber. In further embodiments, the produce input signal also includes information regarding the quantity, mass, or volume of the specified fruit(s) or vegetable(s).

At 620, the method 600 includes determining a cooling condition within the preservation chamber. Generally, the cooling condition may indicate the relative need to adjust or maintain a temperature within the preservation chamber. For instance, the cooling condition of 620 may be initiated or performed in response to the input signal of 610. Optionally, 620 is initiated automatically in response to receiving the activation signal. For instance, 620 may include determining an initial cooling period (e.g., a discrete amount of time or time period) immediately following receiving the activation signal. In some embodiments, 620 includes receiving a temperature signal from a temperature sensor in thermal communication with the preservation chamber, as described above. In further embodiments, 620 includes comparing the temperature signal to a set temperature threshold (e.g., 70° Fahrenheit, 65° Fahrenheit, or 60° Fahrenheit). Thus, 620 may provide for evaluating whether the temperature within the preservation chamber is greater than, equal to, or less than the set temperature threshold that is predetermined or programmed into the controller. In some such embodiments, multiple temperature signals may be received (e.g., at a predetermined detection rate during operation of the preservation device). Thus, the preservation device may detect the change in temperature at the preservation chamber over time. Optionally, multiple discrete temperature thresholds may be provided, such as a first temperature threshold and a second temperature threshold that is greater than the first temperature threshold.

At 630, the method 600 includes directing an airflow through the air passage and the porous evaporative medium. In particular, the fan may be rotated to motivate the airflow based on the determined cooling condition at 620. As described above, the airflow may be directed across an external surface of the inner shell opposite the preservation chamber. Moreover, the airflow may be directed, at least in part, through the porous evaporative medium, such that liquid coolant from the porous evaporative medium vaporizes and mixes or entrains with the airflow (e.g., before flowing to the ambient environment).

As discussed above, the fan may be a variable speed fan. In turn, the fan may selectively vary the rate (e.g., volumetric flow rate) of the airflow through air passage. In some such embodiments, 630 includes motivating the airflow at one of a plurality of velocities based on the determined cooling condition at 620. At least one velocity (e.g., a first velocity) greater than another velocity (e.g., a second velocity). Thus, the rotation speed of the fan may be adjusted according to 620. As an example, if an initial cooling period is determined, 630 may include motivating the airflow from the fan at a first velocity during the initial cooling period. Following the initial cooling period (e.g., immediately after the initial cooling period has ended or, alternatively, immediately following one or more intermediate periods), 630 may include motivating the airflow from the fan at the second velocity. As another example, the velocity of the airflow may be contingent on the received temperature signal(s). If a temperature signal (e.g., at 620) is determined to be greater than or equal to the set temperature threshold, 630 may include motivating the airflow from the fan at the first velocity. If the temperature signal is determined to be less than the set temperature threshold, 630 may include motivating the airflow from the fan at the second velocity. If multiple discrete temperature thresholds are provided, it is understood that additional velocities may be similarly provided.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A countertop produce-preservation device comprising:
a housing comprising an outer shell and an inner shell partially enclosed within the outer shell to define an air passage therebetween, the inner shell defining a produce opening and a preservation chamber to receive produce therein, the outer shell defining an air inlet and an air outlet in fluid communication with the air passage;
a fan in fluid communication with the air passage to motivate an airflow from the air inlet to the air outlet; and
a porous evaporative medium positioned within the outer shell along the air passage to direct a vaporized cooling liquid thereto upstream from the air outlet.

2. The countertop produce-preservation device of claim 1, wherein the preservation chamber is in fluid isolation from the air passage.

3. The countertop produce-preservation device of claim 1, further comprising a liquid reservoir in fluid communication with the porous evaporative medium to supply a liquid coolant thereto, wherein the liquid reservoir is positioned above the porous evaporative medium.

4. The countertop produce-preservation device of claim 1, further comprising a liquid reservoir in fluid communication with the porous evaporative medium to supply a liquid coolant thereto, wherein the liquid reservoir is positioned below the porous evaporative medium.

5. The countertop produce-preservation device of claim 1, wherein the porous evaporative medium is spaced apart from the inner shell.

6. The countertop produce-preservation device of claim 1, wherein the inner shell defines an internal surface and an opposite external surface, wherein the internal surface is directed toward the preservation chamber, wherein the external surface is directed toward the air passage, and wherein the porous evaporative medium is positioned in contact with the external surface of the inner shell.

7. The countertop produce-preservation device of claim 1, further comprising a secondary cooling device positioned within the housing.

8. The countertop produce-preservation device of claim 7, wherein the secondary cooling device comprises a thermo-electric heat exchanger disposed on the inner shell.

9. The countertop produce-preservation device of claim 1, wherein the inner shell comprises a conductive metal.

10. The countertop produce-preservation device of claim 1, wherein the outer shell comprises an insulating polymer.

11. A countertop produce-preservation device comprising:
a housing comprising an outer shell and an inner shell partially enclosed within the outer shell to define an air passage therebetween, the inner shell defining a produce opening and a preservation chamber to receive produce therein, the outer shell defining an air inlet and an air outlet in fluid communication with the air passage;
a fan in fluid communication with the air passage to motivate an airflow from the air inlet to the air outlet;
a porous evaporative medium positioned within the outer shell along the air passage in fluid communication between the air inlet and the air outlet; and
a liquid reservoir in fluid communication with the porous evaporative medium to supply a liquid coolant thereto.

12. The countertop produce-preservation device of claim 11, wherein the preservation chamber is in fluid isolation from the air passage.

13. The countertop produce-preservation device of claim 11, wherein the liquid reservoir is positioned above the porous evaporative medium.

14. The countertop produce-preservation device of claim 11, wherein the liquid reservoir is positioned below the porous evaporative medium.

15. The countertop produce-preservation device of claim 11, wherein the porous evaporative medium is spaced apart from the inner shell.

16. The countertop produce-preservation device of claim 11, wherein the inner shell defines an internal surface and an opposite external surface, wherein the internal surface is directed toward the preservation chamber, wherein the external surface is directed toward the air passage, and wherein the porous evaporative medium is positioned in contact with the external surface of the inner shell.

17. The countertop produce-preservation device of claim 11, further comprising a secondary cooling device positioned within the housing.

18. The countertop produce-preservation device of claim 17, wherein the secondary cooling device comprises a thermo-electric heat exchanger disposed on the inner shell.

19. The countertop produce-preservation device of claim 11, wherein the inner shell comprises a conductive metal.

20. The countertop produce-preservation device of claim 11, wherein the outer shell comprises an insulating polymer.
